(19) United States
(12) Patent Application Publication
(10) Pub. No.: US 2024/0167882 A1
(43) Pub. Date: May 23, 2024

(54) Pyrometer device for laser plastic welding temperature determination and system for laser plastic welding

(71) Applicant: Leister Technologies AG, Kagiswil (CH)

(72) Inventors: Alexander Franke, Kerns (CH); Daniel Csati, Kagiswil (CH)

(21) Appl. No.: 18/510,763

(22) Filed: Nov. 16, 2023

(30) Foreign Application Priority Data
Nov. 17, 2022 (EP) 22 208 140.8

(51) Int. Cl. G01J 5/10; B29C 65/00; G01J 5/0821

(52) U.S. Cl. CPC G01J 5/10; B29C 66/91211; G01J 5/0821; B29C 65/16

(57) ABSTRACT

A pyrometer device for temperature determination in laser plastic welding is provided, wherein the pyrometer device comprises: a first fiber connector for a first optical fiber; a second fiber connector for a second optical fiber; and a radiation temperature sensor; wherein the pyrometer device is adapted to forward process laser radiation received via the first fiber connector to the second fiber connector and output via the second fiber connector; wherein the pyrometer device is adapted to forward thermal radiation received via the second fiber connector to the radiation temperature sensor. Further a system for laser plastic welding with a laser beam source, process optics, and a fiber-coupled pyrometer device is provided.

### CROSS-REFERENCE TO RELATED APPLICATIONS

This application claims the priority of European patent application No. 22 208 140.8, filed Nov. 17, 2022, which is incorporated herein by reference in its entirety.

### TECHNICAL FIELD

The present invention relates to a pyrometer device for temperature determination in laser plastic welding, and further relates to a system for laser plastic welding with a laser beam source, process optics for laser plastic welding and a pyrometer device for temperature determination in laser plastic welding.

### BACKGROUND

Systems for welding plastics, in particular thermoplastics, by hot air and laser radiation are generally known from the state of the art. In laser welding of thermoplastics, a joining partner that is transparent to the laser beam is usually joined to an absorbent joining partner. The laser beam penetrates the transparent plastic, referred to in technical terms as the joining partner, and hits the absorbing plastic. There, the energy of the radiation is converted into heat and the plastic melts. On contact with the transparent plastic, the latter also melts due to thermal conduction and bonds with the absorbing plastic. As soon as both plastics have cooled down, a material bond is formed.

EP 1 366 890 A1 discloses a method and device for joining plastic materials with high welding speed. A method and device for joining endless plastic materials by means of the transmission technique are described. For joining, the endless materials are guided through two contrarotating rollers that press against each other. The first roller consists of a material that is transmissive to laser beams and is tubular. The second roll is formed from a material that can be easily deformed at the surface, so that its surface can adapt to the shape of the first roller. In the first roller, means are arranged for generating a laser beam at the contact surface between the materials to be joined. The beam is thereby provided as a linear laser beam along the direction of movement of the materials, so that continuous heating of the material to the melting point occurs as it passes through, without the need to provide an excessively high laser power. With the method and device, continuous bonding at high speed is possible. For temperature measurement, a pyrometer can be provided for IR-measurement of the temperature. By this measurement the melting zone can be observed and the laser power can be controlled correspondingly. The device for IR-measurement is preferably arranged inside the first roller, thus inside the process head.

EP 3 181 331 A1 discloses a method and a device for connecting at least two workpieces extending in three-dimensions by laser transmission welding, wherein the workpieces are locally pressed together in a joining region by a clamping device. It is provided that the joining region is respectively subdivided into at least two adjacent joining region segments, that are simultaneously or quasi-simultaneously processed by a respective laser beam with a different angle of incidence. In a preferred embodiment of the method, the energy transmitted by the laser beams to the workpieces is controlled. For this purpose, the temperature in the joining region of the workpieces is preferably detected without contact, for example with a pyrometer, and the energy input to the respective joining region segments is adapted depending on the detected temperature, preferably by increasing or decreasing the speed of movement of the laser beam accordingly.

EP 1 405 713 B1 discloses a method for joining workpieces made from plastic, wherein the upper workpiece, facing a laser source, consists of a material transparent to the laser beam and the lower workpiece consists of a material absorbent to the laser beam, such that the adjacent contact surfaces of the two workpieces melt and are joined together during subsequent cooling under pressure, wherein the guiding of the laser beam to the site to be joined and the mechanical pressing together of the workpieces are performed simultaneously by one processing head. In the processing head, an integrated beam splitter can be provided with which thermal radiation emanating from the welding site is deflected to a temperature measuring device.

### SUMMARY

Against this background, it is an object of the present disclosure to provide an improved system for laser plastic welding and a pyrometer device for temperature determination in laser plastic welding. It would be desirable to keep the weight and size of a process head small. Furthermore, it would be desirable to further improve process accuracy, even for existing equipment. Furthermore, it would be desirable to facilitate an adjustment and/or to reduce an installation effort.

According to a first aspect of the present disclosure, a pyrometer device for temperature determination in laser plastic welding is provided, wherein the pyrometer device comprises: a first fiber connector for a first optical fiber; a second fiber connector for a second optical fiber; and a radiation temperature sensor; wherein the pyrometer device is adapted to forward process laser radiation received via the first fiber connector to the second fiber connector and output via the second fiber connector; and wherein the pyrometer device is adapted to forward thermal radiation received via the second fiber connector to the radiation temperature sensor.

According to a further aspect of the present disclosure, a system for laser plastic welding is provided, wherein the system comprises: a laser beam source; a process optics for laser plastic welding; and a pyrometer device for temperature determination in laser plastic welding, in particular as described above; wherein the laser beam source is coupled to the first fiber connector of the pyrometer device via a first optical fiber; and wherein the process optics is coupled to the second fiber connector of the pyrometer device via a second optical fiber.

Accordingly, in the solution according to an aspect of the present invention, for laser plastic welding, a novel embodiment and arrangement of a pyrometer device for temperature determination is proposed, wherein a fiber-coupled pyrometer device can be inserted as an inserted module between a fiber-coupled laser beam source for process laser radiation at the first fiber connector and a fiber-coupled process head at the second fiber connector. The pyrometer device can in its own housing be inserted into a fiber path between the fiber-coupled laser beam source and the fiber-coupled process head (also referred to as process optics). That is, an optical fiber comes from the laser beam source, leads into the proposed pyrometer device, from the pyrometer device comes a second optical fiber, which in turn can lead to a process optic which can project radiation from the second optical fiber onto the workpiece for welding. Accordingly, the process laser radiation first passes through the first optical fiber and then through the second optical fiber toward the workpiece. The thermal radiation from the workpiece, on the other hand, travels in the opposite direction through the second optical fiber to the radiation temperature sensor (also referred to as a pyrometer) of the pyrometer device.

In contrast thereto, the prior art in the field of laser plastic welding discloses other approaches. For process monitoring, on the one hand, a separate pyrometer can thus be used, which is not located in the radiation path of the process laser beam. On the other hand, in legacy solutions, process optics with a pyrometer integrated into the process optics can be used.

However, aspects of the present invention can offer some advantages over this. Since the radiation temperature sensor is not arranged in the process optics (in the process head), the process optics can be made particularly light and/or small. This can for example enable fast movements of the process optics with a robot. A further advantage can be that a robot arm with a lower load-bearing capacity can be used to move the thereby lighter process optics. A further advantage can be that no electronic components need to be included in the process optics. This can improve resiliency against electromagnetic radiation or EMC. A further advantage can be that the pyrometer device can be arranged at a distance from the process optics. In particular, the pyrometer device can be fixedly mounted in one location, with distance from the process optics, free from potential movements, vibrations and/or electromagnetic field exposure.

A further advantage can be that the process accuracy of preexisting systems can be further improved retroactively. For example, existing laser welding systems that previously did not have a pyrometer can be upgraded retroactively. For this, the proposed pyrometer device can be inserted into a fiber link between an existing (laser) beam source for process laser radiation and an existing process optics. The beam source is connected to the first fiber connector with a first optical fiber. The process optics is connected to the second fiber connector with a second optical fiber. The pyrometer device is adapted to forward the process laser radiation received via the first fiber connector to the second fiber connector and to output it via the second fiber connector, so that the process laser radiation can be fed to the workpiece via the process optics. Thermal radiation emitted from the workpiece enters the second optical fiber in the reverse direction via the process optics. The pyrometer device is adapted to pass thermal radiation received via the second fiber connector to the radiation temperature sensor. An advantage of the proposed solution can also be that different process optics can be used flexibly. Accordingly, it is not necessary to provide each process optics with a respective integrated pyrometer. Instead, the proposed fiber-coupled pyrometer device can be used with different process optics without integrated pyrometers. Thereby the system costs when using different process optics can be further reduced. In particular, existing process optics can continuously be used and subsequently upgraded by the proposed pyrometer device.

The first and/or second fiber connector can, for example, be an IPG collimator connector or SMA connector. In the context of the present disclosure, an SMA connector can refer to an F-SMA connector according to IEC 61754-22. The first fiber connector can be, for example, an IPG collimator connector. The second fiber connector can be, for example, an F-SMA connector according to IEC 61754-22. In the context of the present disclosure, the term fiber connector can refer to a connector for an optical fiber (optically conductive fiber, light guide or optical fiber cable) such as an optical fiber made of glass or an optical plastic fiber. In the context of the present disclosure, a process optics can refer to a process head with which the process radiation for laser plastic welding is provided to a workpiece. In particular, the process head can comprise a fiber connector for the second optical fiber. The process head can further comprise one or more beam shaping elements, such as lenses, DOEs (diffractive optical elements), etc.

The pyrometer device can be adapted to receive process laser radiation provided by an external beam source via the first fiber connector, to forward the process laser radiation to the second fiber connector, and output the process laser radiation via the second fiber connector. The pyrometer device can be adapted to forward thermal radiation received from an external process optics via the second fiber connector to the radiation temperature sensor.

In other words, the process laser radiation is provided by an external laser beam source. The laser beam source used can, for example, be a fiber-coupled diode laser or a fiber laser. The laser radiation is provided via the first optical fiber at the first fiber connector. The process optics can in turn be connected via the second optical fiber at the second fiber connector. The process laser radiation is fed to the workpiece via the process optics, for example focused onto the workpiece as a free beam. The thermal radiation can be received in the opposite direction from the external process optics and forwarded via the second optical fiber and the second fiber connector to the radiation temperature sensor.

The pyrometer device can comprise a partially transmissive mirror. The partially transmissive mirror can be arranged and adapted to forward the process laser radiation from the first fiber connector to the second fiber connector. The partially transmissive mirror can be arranged and adapted to forward thermal radiation received via the second fiber connector to the radiation temperature sensor. Hereby, either the thermal radiation or the process laser radiation can be redirected. In other words, the partially transmissive mirror can be transmissive to the thermal radiation and redirect the process laser radiation. Alternatively, the partially transmissive mirror can be transmissive to the process laser radiation and redirect the thermal radiation.

In a further refinement, the first fiber connector, the second fiber connector, the partially transmissive mirror, and the radiation temperature sensor can be arranged and adapted such that the partially transmissive mirror reflects and redirects the process laser radiation from the first fiber connector to the second fiber connector; and the partially transmissive mirror is adapted to let the thermal radiation received via the second fiber connector pass through and forward to the radiation temperature sensor. In this example, a partially transmissive mirror is thus inserted, which reflects the laser radiation, and passes the thermal radiation.

The pyrometer device can comprise a first adjustment device that is adapted to adjust (or optimize) an optical coupling between the first fiber connector and the second fiber connector. The first adjustment device can, for example, be adapted to shift a position of the first fiber connector relative to the second fiber connector and/or to adapt an incidence angle. However, the first adjustment device can also be adapted to adjust an optical element such as a focusing lens for the second fiber connector relative thereto. The first adjustment device can also be adapted to adjust the partially transmissive mirror to thereby adjust an optical coupling between the first fiber connector and the second fiber connector. An advantage of this embodiment can be simple, flexible and/or precise assembly.

In addition or in the alternative, the pyrometer device can comprise a second adjustment device adapted to adjust (or optimize) an optical coupling between the second fiber connector and the radiation temperature sensor. The second adjustment device can, for example, be adapted to shift a position of the second fiber connector relative to the radiation temperature sensor and/or to adapt an incident angle. In particular, the second adjustment device can be adapted to adjust a position of the radiation temperature sensor. However, the second adjustment device can also be adapted to adjust an optical element such as a focusing lens for the second fiber connector relative thereto. The second adjustment device can also be adapted to adjust the partially transmissive mirror to thereby adjust an optical coupling between the radiation temperature sensor and the second fiber connector. An advantage of this embodiment can be simple, flexible and/or precise assembly.

The process laser radiation can have a wavelength in the range of 900 nm to 1,100 nm. The thermal radiation can have a wavelength in the range of 1,700 nm to 2,300 nm. The process laser radiation can be in the center or at the edge of an evaluable (detectable or analyzable) spectrum of the radiation temperature sensor. An advantage of this embodiment can be that an optical fiber, in particular a glass optical fiber, is sufficiently transparent in both wavelength ranges. The process laser radiation is, for example, in the range of 1 μm wavelength. The transmissivity of most optically transparent plastics often decreases significantly above 2.3 μm wavelength. Thus, on the one hand, an advantageous energy input can be achieved with the process laser radiation and, on the other hand, process monitoring can be carried out by thermal radiation in a wavelength range which can also be transported by the second optical fiber on the return path.

A spectral filter can optionally be arranged in front of the radiation temperature sensor of the pyrometer device, which is adapted to block the process laser radiation. An advantage of this embodiment can be that the measurement accuracy can be further improved. Furthermore, the radiation temperature sensor can be protected from the process laser radiation. In particular, since the thermal radiation is received via the second fiber connector, via which the process laser radiation also reaches the workpiece, it can thus be avoided that an excessive amount of process laser radiation reaches the radiation temperature sensor.

The pyrometer device can comprise a first optical fiber that is connected to the first fiber connector. The pyrometer device can comprise a second optical fiber that is connected to the second fiber connector. In other words, the first optical fiber and/or the second optical fiber can be part of the pyrometer device. An advantage of this embodiment may be that proper coupling and/or adjustment such that process laser radiation received via the first fiber connector is forwarded to the second fiber connector and output via the second fiber connector; and/or such that thermal radiation received via the second fiber connector is forwarded to the radiation temperature sensor can be done in advance, in particular before delivery to customers. For use, the laser beam source would simply have to be connected to the first optical fiber and the process optics would have to be connected to the second optical fiber.

The second optical fiber can have a larger core diameter than the first optical fiber. A core diameter of the second optical fiber to the process optics is thus preferably larger than the core diameter of the optical fiber to the laser beam source. For example, the first optical fiber to the laser beam source can have a first core diameter of 300 μm and the second optical fiber to the process optics can have a second core diameter of 600 μm. An advantage of this embodiment can be that precise beam guiding of the laser light and easy coupling can be provided. The combination of a first optical fiber with a smaller core diameter and a second optical fiber with a larger diameter can facilitate relaying or forwarding of the process radiation to the second fiber connector and/or facilitate feedback from the process optics. According to a second example, the second optical fiber can have a core diameter of 220 μm and the first optical fiber can have a core diameter of 200 μm. The combination of a first optical fiber with a second optical fiber having a larger core diameter can be advantageous in the proposed pyrometer device, since a beam quality may be degraded by any imaging errors or alignment deviations when the process laser radiation is coupled over or forwarded from the first fiber connector to the second fiber connector. The proposed combination can facilitate assembly and alignment, and accommodate any beam quality degradation.

In addition or in the alternative, the second optical fiber can have a larger beam parameter product, BPP, than the first optical fiber. The beam parameter product can be regarded as a measure of beam quality. It is proportional to the beam diameter and its divergence. The selection of a second optical fiber with larger BPP facilitates the transition or forwarding of the process laser radiation from the first to the second optical fiber, since the BPP can be degraded by imaging or aberrations, etc. Advantageously, a second optical fiber with larger core diameter and/or larger numerical aperture, NA, is provided, i.e., a second optical fiber with larger BPP. Compared to other solutions, such as the use of a pinhole, an advantage of this approach is that the efficiency of beam transmission is not reduced by a pin aperture and an aperture would likely need to be cooled in the specific application scenario of laser plastic welding.

The pyrometer device can comprise a power meter for measuring a laser power of the process laser radiation received via the first fiber connector. An advantage of this solution is a synergistic effect, since the power meter and the pyrometer can be retrofitted together in one step. In addition or in the alternative, the pyrometer device can comprise a (pointer) light source and be adapted to output light from the light source, in particular visible light, via the second fiber connector. An advantage of this solution is that no pointer light source is required in the process optics or in the laser beam source. The process optics can thus be manufactured more cost-effectively. This is in particular advantageous if different changeable process optics are to be used. A further advantage can be that also different laser beam sources for the process laser beam can be used and a pointer light source in the laser beam source, which is connected via the first fiber connector, is no longer needed. There can also be an advantage for the beam path in the pyrometer device since only the process laser radiation has to be forwarded from the first fiber connector to the second fiber connector, but not yet an additional optical wavelength deviating therefrom for a pointer light source provided in the laser beam source. This is particularly important because the wavelength of the pointer light source (wavelength in the visible spectral range) and the wavelength of the process laser radiation (usually laser radiation in the infrared spectral range) are different.

It is to be understood that the pyrometer device can comprise a communication interface for providing measurement data of the radiation temperature sensor and/or of the power meter. For example, there can be a data connection of the pyrometer device to further components of a manufacturing equipment or a system for laser plastic welding. Data from the pyrometer device can be stored for documentation purposes or used for (online) process control. For example, a laser power or feed rate of the workpiece or process head can be controlled based on the measured data from the temperature sensor. An advantage of the proposed pyrometer device can be in particular that also an existing equipment can be retrofitted by a measurement data acquisition with a radiation temperature sensor by the pyrometer device.

In the system for laser plastic welding, the laser beam source can be arranged at a distance from the pyrometer device. Similarly, the process optics can be arranged at a distance from the pyrometer device. The laser beam source can be connected to the first fiber connector of the pyrometer device via a first optical fiber. The process optics can be connected to the second fiber connector of the pyrometer device via a second optical fiber. The laser beam source can be a fiber-coupled diode laser or a fiber laser.

An advantage of the proposed solution can be in particular that no significant changes to the process optics have to be made. Existing process optics can be used and subsequently upgraded.

Advantages described in detail above for the first aspect of the invention apply correspondingly to the further aspects of the invention.

It is to be understood that features mentioned above and those yet to be explained below may be used not only in the combination respectively indicated, but also in other combinations or separately, without departing from the scope of the present invention.

### BRIEF DESCRIPTION OF THE DRAWINGS

Exemplary embodiments of aspects of the invention are illustrated in the following drawings and explained in more detail in the following description.

FIG. 1 shows a schematic diagram of a conventional system for laser plastic welding;

FIG. 2 shows a schematic diagram of a system for laser plastic welding with a fiber-coupled pyrometer device;

FIG. 3 shows a perspective view of a first embodiment of a pyrometer device;

FIG. 4 shows a top view of the pyrometer device of FIG. 3;

FIG. 5 shows a perspective view of a second embodiment of a pyrometer device; and

FIG. 6 shows a top view of the pyrometer device of FIG. 5.

### DETAILED DESCRIPTION

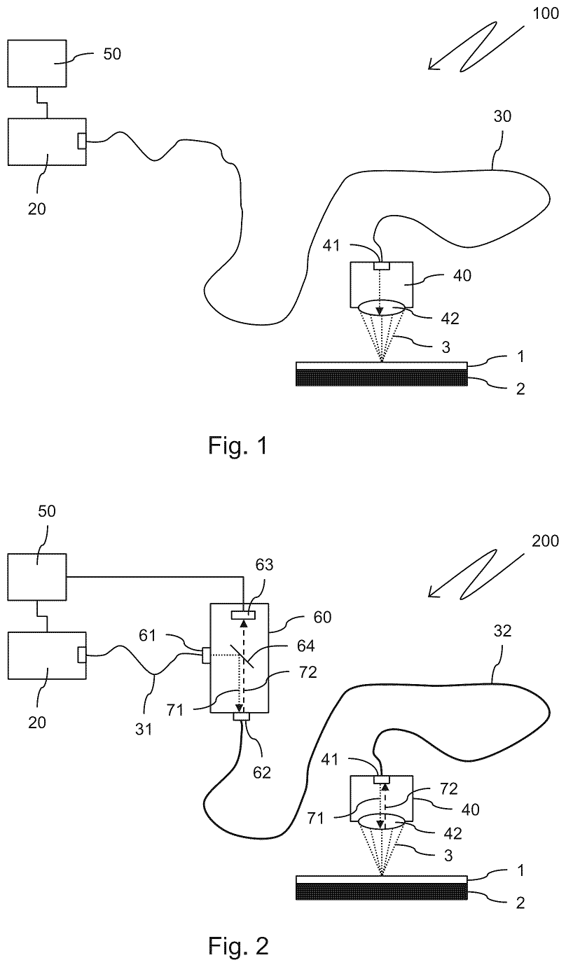

FIG. 1 shows a schematic diagram of a conventional system 100 for laser plastic welding. In the shown example, a transparent joining partner 1 and an absorbent joining partner 2 are welded by a process laser beam 3. The laser beam 3 penetrates the transparent plastic 1 and hits the absorbing plastic 2, where the energy of the radiation is converted into heat and the plastic melts. On contact with the transparent plastic 1, the latter also melts and bonds with the absorbing plastic 2. As soon as both plastics have cooled, a material bond is formed.

The conventional system 100 comprises a laser beam source 20 connected via an optical fiber 30 to a process head 40. The laser beam source 20 used can be, for example, a fiber-coupled diode laser or a fiber laser. The process head 40 comprises a fiber connector 41 for the optical fiber 30. The process head 40 can further comprise one or more beam guiding elements 42, such as lenses, DOEs (diffractive optical elements), etc., to provide the laser radiation to the workpiece with the two joining partners 1, 2. The system can further comprise a controller 50 for controlling the laser beam source 20. For example, a power of the laser beam source 20 can be adjusted.

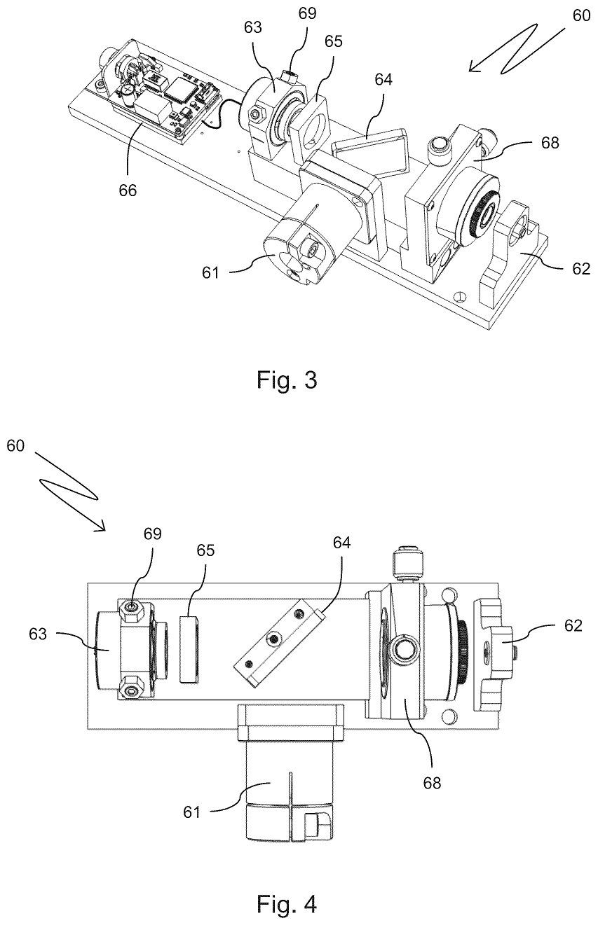

FIG. 2 shows a schematic illustration of a system 200 for laser plastic welding, which in addition comprises a fiber-coupled pyrometer device 60 for temperature determination in laser plastic welding. The pyrometer device 60 comprises a first fiber connector 61 for a first optical fiber 31. The first optical fiber 31 connects the laser beam source 20 to the pyrometer device 60. The pyrometer device 60 further comprises a second fiber connector 62 for a second optical fiber 32. The second optical fiber 32 connects the pyrometer device 60 to the process head 40. The process head 40 can be a conventional process head, in particular a process head without an integrated pyrometer device. Further embodiments of pyrometer devices 60 are shown in detail in FIGS. 3 to 6.

The pyrometer device 60 is adapted to receive process laser radiation provided by the external laser beam source 20 via the first fiber connector 61, to forward the process laser radiation to the second fiber connector 62, and to output the process laser radiation via the second fiber connector 62. The process laser radiation is guided from the second fiber connector 62 to the process head 40 via the second optical fiber 32. However, not only is the process laser radiation guided from the pyrometer device 60 to the process head 40 via the second optical fiber 32. In addition thermal radiation received from the process head 40 is guided in the opposite direction via the second optical fiber to the pyrometer device 60. The process laser radiation is denoted by reference sign 71. The thermal radiation emitted from the workpiece is denoted by reference sign 72. The pyrometer device 60 is adapted to forward thermal radiation 72 received via the second fiber connector 62 from the external process optics 40 to a radiation temperature sensor 63 of the pyrometer device. The radiation temperature sensor 63 can also be referred to as a pyrometer.

The pyrometer device 60 can for example comprise a partially transmissive mirror 64 arranged and adapted (a) to forward the process laser radiation from the first fiber connector to the second fiber connector and (b) to forward the thermal radiation received via the second fiber connector to the radiation temperature sensor, as illustrated in FIG. 2. In the example shown, the process laser radiation 71 is redirected. In the shown example, the first fiber connector, the second fiber connector, the partially transmissive mirror, and the radiation temperature sensor are arranged and adapted such that the partially transmissive mirror 64 reflects and redirects the process laser radiation from the first fiber connector 61 to the second fiber connector 62; and the partially transmissive mirror 64 allows the thermal radiation received via the second fiber connector to pass through and forward to the radiation temperature sensor 63.

The proposed pyrometer device can preferably also be retroactively inserted into a fiber path between a laser beam source 20 and a process head 40 to retroactively upgrade a system 200 for laser plastic welding. A further advantage may be that, depending on the respective requirements, different process heads 40 and/or different laser beam sources 20 can be used. The pyrometer device 60 can be arranged at a distance from the process head 40. Thus, smaller and lighter process heads can be used. Further advantages have already been described in the introduction.

As indicated in FIG. 2 by different line widths of the first optical fiber 31 and the second optical fiber 32, the second optical fiber 32 preferably has a larger core diameter than the first optical fiber 31. In addition or in the alternative, the second optical fiber 32 can have a larger beam parameter product, BPP, than the first optical fiber 31. For example, the first optical fiber 31 to the laser beam source 20 can have a first core diameter of 300 μm and the second optical fiber 32 to the process optics 40 can have a second core diameter of 600 μm. According to a second example, the second optical fiber 32 can have a core diameter of 220 μm and the first optical fiber 31 can have a core diameter of 200 μm. This embodiment facilitates the transfer from the first optical fiber 31 to the second optical fiber 32 in the pyrometer device 60.

The system 200 for laser plastic welding system can also comprise a controller 50 for controlling the laser beam source 20. The controller 50 can further be connected to the radiation temperature sensor 63, for example via a communication interface, with which measurement data from the radiation temperature sensor is transferred to the controller. Thus, process monitoring of the welding process can be performed. In particular, the laser power of the laser beam source 20 can be controlled such that a desired temperature is achieved at the welding spot. In addition or in the alternative, a feed rate of the workpiece and process head 40 relative to each other can be controlled based on the temperature measured by the radiation temperature sensor 63.

FIG. 3 and FIG. 4 show a perspective view and a top view of a first embodiment of a pyrometer device 60. The pyrometer device 60 again comprises the first fiber connector 61 for the first optical fiber 31, the second fiber connector 62 for the second optical fiber 32, and the radiation temperature sensor 63. The first fiber connector 61 can be, for example, an IPG collimator port. The second fiber connector 62 can be, for example, an F-SMA connector according to IEC 61754-22. However, other connectors can also be used. A partially transmissive mirror 64 forwards the process laser radiation received via the first fiber connector 61 to the second fiber connector 62. The partially transmissive mirror 64 is transmissive to thermal radiation received via the second fiber connector 62 and forwards it to the radiation temperature sensor 63.

Optionally, a filter 65 can be provided in front of the radiation temperature sensor 63. The filter 65 is adapted to block or attenuate the process laser radiation. Thereby the radiation temperature sensor 63 is protected from the process laser radiation and a better measurement result can be achieved when measuring the temperature of the weld.

FIG. 3 shows an additional electronic module in the form of a circuit board 66 which is connected to the radiation temperature sensor 63. This can be components for operating the radiation temperature sensor 63 and/or a communication interface for connection to the controller 50, as shown in FIG. 2.

As shown in FIGS. 3 and 4, the pyrometer device 60 can comprise a first adjustment device 68 adapted to adjust optical coupling between the first fiber connector 61 and the second fiber connector 62. For example, an adjustment in an x-y plane orthogonal to a main beam direction, a beam deflection and/or a focusing of the process laser radiation can be performed, preferably such that the process laser radiation is transferred from the first fiber connector 61 to the second fiber connector 62 with as little loss as possible. In principle, the pyrometer device 60 can comprise the first optical fiber 31 connected to the first fiber connector 61 and/or the second optical fiber 21 connected to the second fiber connector 62. Thus, the first optical fiber and/or the second optical fiber can already be part of the pyrometer device 60. In this case, an adjustment can already be performed when manufacturing the pyrometer device 60. This facilitates the assembly at the customer.

The pyrometer device can, in addition or in the alternative, comprise a second adjustment device 69 adapted to adjust optical coupling between the second fiber connector 62 and the radiation temperature sensor 63. In the present example, the second adjustment device 69 can be integrated in a holder for the radiation temperature sensor 63. However, it is also possible to provide a separate adjustment device 69.

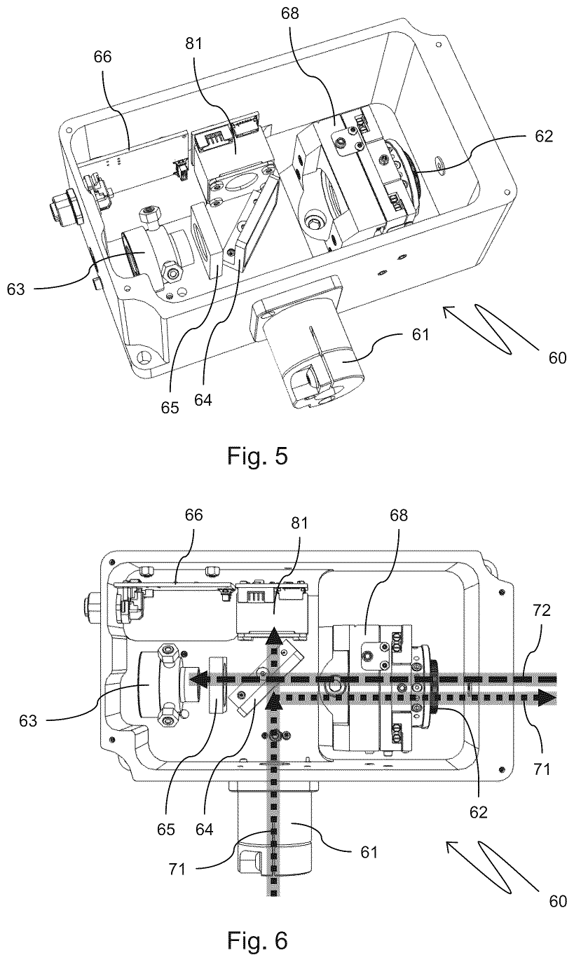

FIG. 5 and FIG. 6 show a perspective view and a top view of a further embodiment of a pyrometer device 60. The pyrometer device can comprise a housing in which the optical components of the pyrometer device are arranged. The shown embodiment provides a compact assembly and can be easily retrofitted into a fiber path between the laser beam source 20 and the process optics 40. The beam paths for the process laser radiation 71 and the thermal radiation 72 are highlighted in the top view in FIG. 6.

As shown in FIGS. 5 and 6, the pyrometer device can further comprise a power meter 81 for measuring a laser power of the process laser radiation received via the first fiber connector. The partially transmissive mirror transmits most of the process laser radiation 71 received via the first fiber connector 61 to the second fiber connector 62. However, a smaller portion is not reflected and reaches the power meter 81. Due to the deflection by the partially transmissive mirror 64, an optical attenuator or neutral density filter in front of the power meter 81 can optionally be omitted. This can reduce manufacturing costs and simplify the assembly.

Optionally, the pyrometer device can comprise an integrated light source, also referred to as a pointer light source (not shown), which is adapted to output light from the light source, in particular visible light, via the second fiber connector. The light from the pointer light source can, for example, be coupled into the beam path via a further partially transmissive mirror. The light from the pointer light source is also guided to the workpiece via the second optical fiber and the process optics, and can serve an optical marker of the area heated by the process laser radiation for a user. This facilitates the positioning of the process head and workpiece.

In conclusion, with the solutions proposed herein, an improved system for laser plastic welding and a pyrometer device for temperature determination during laser plastic welding can be provided. In particular, existing systems can also be retrofitted or upgraded retroactively. In addition, the weight and size of a process head can be kept low.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

What is claimed is:

1. A pyrometer device for temperature determination in laser plastic welding, comprising:
a first fiber connector for a first optical fiber;
a second fiber connector for a second optical fiber; and
a radiation temperature sensor;
wherein the pyrometer device is adapted to forward process laser radiation received via the first fiber connector to the second fiber connector and output via the second fiber connector;
wherein the pyrometer device is adapted to forward thermal radiation received via the second fiber connector to the radiation temperature sensor.

2. The pyrometer device according to claim 1, wherein the pyrometer device is adapted to receive process laser radiation provided by an external beam source via the first fiber connector, to forward the process laser radiation to the second fiber connector, and to output the process laser radiation via the second fiber connector.

3. The pyrometer device according to claim 1, wherein the pyrometer device is adapted to forward thermal radiation received from an external process optics via the second fiber connector to the radiation temperature sensor.

4. The pyrometer device according to claim 1, wherein the pyrometer device comprises a partially transmissive mirror arranged and adapted (a) to forward process laser radiation from the first fiber connector to the second fiber connector and (b) to forward thermal radiation received via the second fiber connector to the radiation temperature sensor.

5. The pyrometer device as claimed in claim 4, wherein the first fiber connector, the second fiber connector, the partially transmissive mirror, and the radiation temperature sensor are arranged and adapted such that
the partially transmissive mirror reflects and redirects the process laser radiation from the first fiber connector to the second fiber connector; and
the partially transmissive mirror is adapted to let the thermal radiation received via the second fiber connector pass through and forward to the radiation temperature sensor.

6. The pyrometer device according to claim 1, wherein the pyrometer device further comprises a first adjustment device adapted to adjust optical coupling between the first fiber connector and the second fiber connector.

7. The pyrometer device according to claim 1, wherein the pyrometer device further comprises a second adjustment device adapted to adjust optical coupling between the second fiber connector and the radiation temperature sensor.

8. The pyrometer device according to claim 1, wherein the process laser radiation has a wavelength in the range of 900 nm to 1,100 nm and/or wherein the thermal radiation has a wavelength in the range of 1,700 nm to 2,300 nm; and/or wherein the process laser radiation is in the center or at the edge of an evaluable spectrum of the radiation temperature sensor.

9. The pyrometer device according to claim 1, wherein a spectral filter is arranged in front of the radiation temperature sensor and adapted to block the process laser radiation.

10. The pyrometer device according to claim 1, wherein the pyrometer device further comprises:
a first optical fiber connected to the first fiber connector; and/or
a second optical fiber connected to the second fiber connector.

11. The pyrometer device according to claim 10, wherein the second optical fiber has a larger core diameter than the first optical fiber.

12. The pyrometer device according to claim 11, wherein the second optical fiber has a larger beam parameter product, BPP, than the first optical fiber.

13. The pyrometer device according to claim 10, wherein the second optical fiber has a larger beam parameter product, BPP, than the first optical fiber.

14. The pyrometer device according to claim 1, wherein the pyrometer device further comprises (a) power meter for measuring a laser power of the process laser radiation received via the first fiber connector; and/or (b) a light source and is adapted to output light from the light source via the second fiber connector.

15. A system for laser plastic welding, comprising:
a laser beam source for laser plastic welding;
a process optics for laser plastic welding;
a pyrometer device for temperature determination in laser plastic welding according to claim 1;
wherein the laser beam source is coupled to the first fiber connector of the pyrometer device via a first optical fiber; and
wherein the process optics is coupled to the second fiber connector of the pyrometer device via a second optical fiber.

16. The system for laser plastic welding according to claim 15, wherein the laser beam source is a fiber-coupled diode laser or a fiber laser.
